(19) United States
(12) Patent Application Publication
(10) Pub. No.: US 2006/0146521 A1
(43) Pub. Date: Jul. 6, 2006

(54) Illuminating Carryon Bags, Hand Bags, Wallet, and Luggage

(76) Inventor: Wallace O.M. Despeines, Miami, FL (US)

Correspondence Address: Wallace OM Despeines, 1034 N.E 209 Terrace, Miami, FL, 33179, US

(21) Appl. No.: 10/905,416

(22) Filed: Jan. 3, 2005

(51) Int. Cl. F21V 33/00

(52) U.S. Cl. 362/155

(57) ABSTRACT

Carryon Bag, Suitcase, Wallet, and Luggage that come with a light inside to provide or to glow with light to make it clear or visible to see inside the bag, suitcase, wallet, luggage in the night.

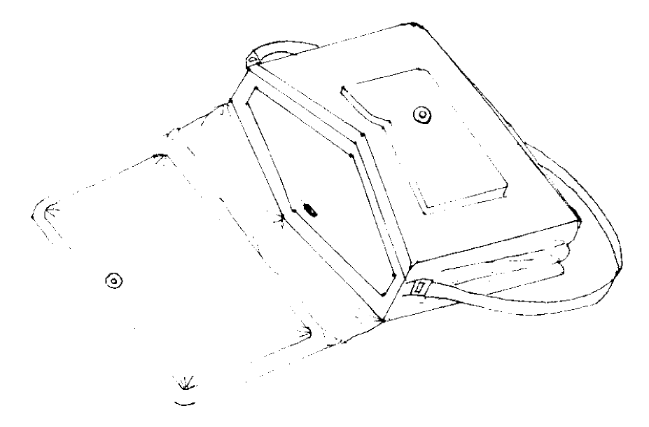

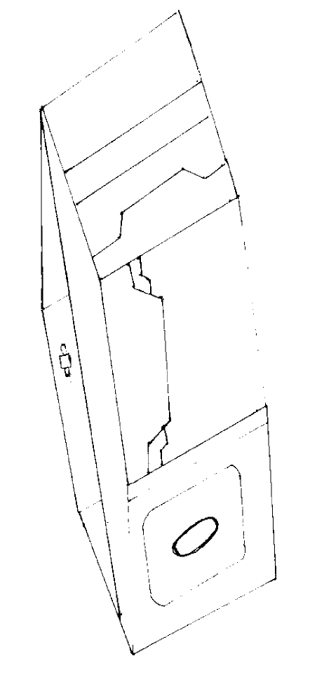

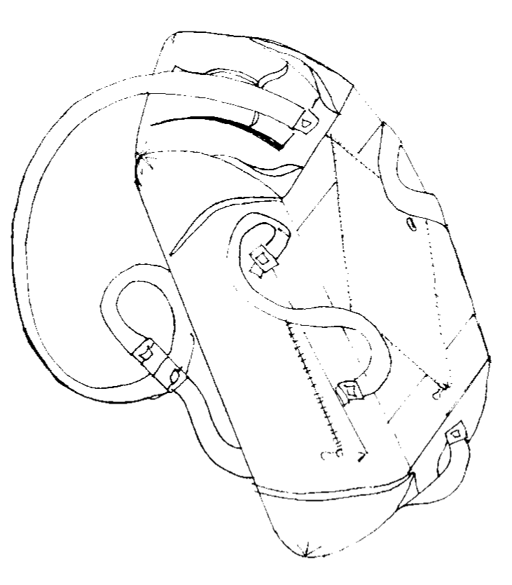

Carryon bags such as Purse, Wallet, and Luggage that will come with a light inside.

It's useful purpose will be in the nighttime when it's dark, while opening it, it will illuminate or glow. Useful for senior citizen, Children, women, men, and travelers. Some light will function with battery or no battery.

What is claimed is:

1. An Illuminating Hand bag that comes with a light inside.

2. A Lightning Travel Bag that illuminates when open or unzip.

3. An Illuminating Wallet that comes with a tiny light inside, it illuminates when open/unfold.
